(19) United States
(12) Patent Application Publication
(10) Pub. No.: US 2012/0209929 A1
(43) Pub. Date: Aug. 16, 2012

(54) METHOD AND APPARATUS FOR ENABLING MESSAGING BETWEEN USERS OF DIFFERENT SOCIAL NETWORKS AND BETWEEN USERS OF SOCIAL NETWORKS AND USERS OF OTHER COMMUNICATION SYSTEMS

(75) Inventors: Hanan BERCU, Ramat Hasharon (IL); Eshed DONI, Or Yehuda (IL); Ofer KALISKY, Raanana (IL); Ornit SHINAR, Ramat Hasharon (IL)

(73) Assignee: SENDM LTD., Or Yehuda (IL)

(21) Appl. No.: 13/453,795

(22) Filed: Apr. 23, 2012

Related U.S. Application Data
(63) Continuation of application No. 12/564,405, filed on Sep. 22, 2009, now abandoned.
(60) Provisional application No. 61/192,603, filed on Sep. 22, 2008.

(51) Int. Cl. G06F 15/16

(52) U.S. Cl. 709/206

(57) ABSTRACT

A method for enabling messaging between users of different social networks is disclosed. Additionally, a method for enabling messaging between users of social networks and users of other communication systems which are not social networks is displosed. This is done by providing an identification mechanism to allocate unique user IDs guaranteeing user ID uniquness across the different social networks and the other communication systems and by a mediation system comprised of social network specific and communication system specific interfaces and a mediation server connected to these interfaces.

The present application is a Continuation of application Ser. No. 12/564,405, filed Sep. 22, 2009, which in turn claims priority from provisional Application No. 61/192,603 filed on Sep. 22, 2008 and entitled “Method and apparatus for enabling messaging between users of different social networks and between users of social networks and users of other communication systems”, which is incorporated herein by reference. The disclosure of the prior applications in hereby incorporated by reference herein in its entirety.

### FIELD OF THE INVENTION

The present invention relates to social networks and specifically to messaging between different social networks.

### BACKGROUND OF THE INVENTION

Social networking has created powerful new ways to communicate and share information. Social networking websites are being used regularly by millions of people, and it now seems that social networking will be an enduring part of everyday life. The main types of social networking services are those which contain directories of some categories (such as former classmates), means to connect with friends (usually with self-description pages), and recommender systems linked to trust. Popular methods now combine many of these, with MySpace and Facebook being the most widely used in North America; Bebo, MySpace, Facebook and Hi5 in parts of Europe; Orkut and Hi5 in South America and Central America; and Friendster, Orkut, and Cyworld in Asia and the Pacific Islands.

One of the common features provided by all the social-networks is the ability of users of the same social-network to send messages to each other. In some cases this option is limited to one-to-one messages and in other cases it also allows one-to-many and many-to-many messages. However, users of a specific social-network are not capable of sending messages to users of other social networks or to user of other communication systems.

The claimed invention facilitates users of different social-networks to send one-to-one, one-to-many and many-to-many messages to each other as well as to users of other communication systems which are not social networks.

### SUMMARY OF THE INVENTION

Technical problem: users of different social networks cannot communicate through the social networks they use with users of other social networks or with users of other communication systems which are not social networks.

The following definitions are employed in the context of the present specification.

Each of the following constitutes one suitable definition for the respective terms; alternative definitions known in the art can also be applied to the various terms appearing herein:

| Term | Definition |
|---|---|
| Social network | A social network focuses on building |
| | online communities of people who share |
| | interests and activities, or who are |
| | interested in exploring the interests and |
| | activities of others. Most social network |
| | services are web based and provide a |
| | variety of ways for users to interact, such |
| | as e-mail and instant messaging services. |
| Social network user | A user of a Social Network |
| SMS | Short Messaging Service. A system used |
| | to deliver textual messages |
| SMS message | A message delivered via SMS |
| Text message | A logical textual message. Each message |
| | has an originator and 1 or more recipients. |
| | Each message contains content. |
| | Technically, a text message might be |
| | implemented as an SMS message. |
| Message | A text message |
| Message originator | The sender of a message. Can be a social |
| | network user or a mobile user |
| Message recipient | A recipient of a message. Can be a social |
| | network user or a mobile user |
| Messaging system | A system which enables messaging |
| | between its users. Every social-network |
| | which provides a messaging feature is a |
| | messaging system |
| Cross Messaging | A message sent by user of a messaging |
| system message | system to a user of a different messaging |
| | system |
| User ID | A unique identifier of a user |
| One-to-one message | A message which has a single originator |
| | and a single recipient. |
| One-to-many message | A message which has a single originator |
| | and several recipients. |
| Message sequence | A collection of messages which is created |
| | by a message, a response to this message, |
| | a response to the previous response, etc. A |
| | message sequence is usually sorted |
| | chronologically |

It is an object of a preferred embodiment of the present invention to provide a system and method for cross-social-networks communication.

It is another object of another preferred embodiment of the present invention to facilitate messaging between users of social networks and users of other communication systems.

Other communication system might be a mobile network on which users are identified by their mobile number (also known as MSISDN). Similarly, other communication system might be e-mail system on which users are identified by their e-mail address.

To allow cross-social-networks messaging, the present invention uses a unique user ID. To ensure that user IDs are unique across any number of social networks as well as other messaging systems, the present invention uses unique user IDs that are composed of a unique messaging system ID, uniquely identifying the messaging system the user is registered to, and the user's unique ID on the said messaging system. To send a message, a user of a messaging system specifies the IDs of all the message recipients by specifying the messaging system ID of the messaging system the receiving user belongs to and the user ID of that recipient on the said messaging system. The system which is described by the current invention routes the message through mediation components to the target messaging system which is then processing it and delivering it to the recipient using that user's unique ID on the same messaging system. The recipient of the message will see an indication of the sender's messaging system as well as the sender's user ID on the same messaging system and will be able to reply to the message, forward it to other recipients, etc. In case of a many-to-many message, every message recipient will see an indication of the other message recipients messaging system as well as their user IDs on the same messaging systems.

Among advantages of the present invention, that it enables to eliminate the barriers which prevented until now communication and specifically messaging between users of different communication and specifically messaging systems

### DETAILED DESCRIPTION OF EMBODIMENTS

In order to understand the invention and to see how it may be carried out in practice, a preferred embodiment will now be described, by way of non-limiting example only, with reference to the accompanying drawings.

Preferred embodiments of the present invention are illustrated in the following drawings:

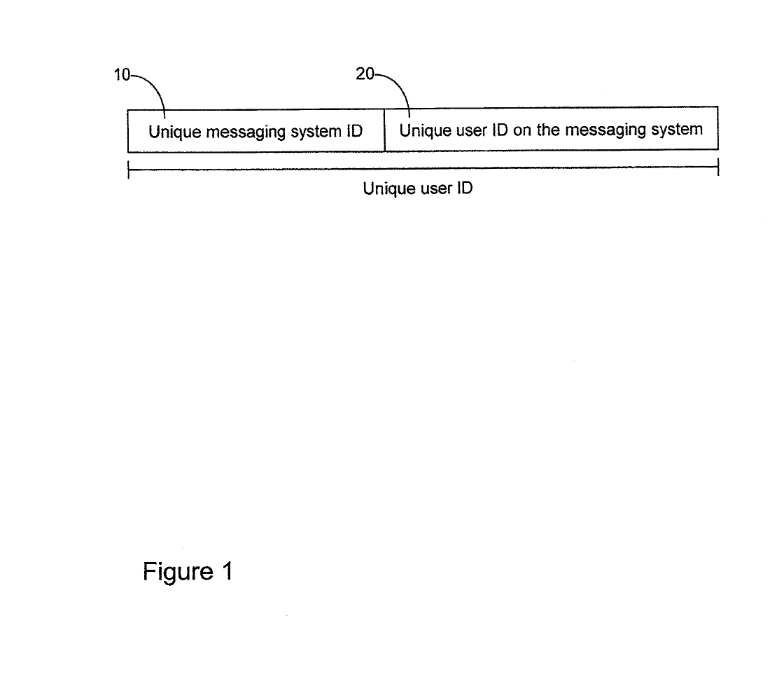

FIG. 1 is a diagram illustration of the unique user ID which is unique across all the different messaging systems and is composed of a unique messaging system ID (box #10) and a unique user ID on that messaging system (box #20). The use of a unique ID across all the different messaging systems is a key element of the present invention as it provides a ubiquitous addressing mechanism using which users of different messaging systems can be addressed in a unified manner. Furthermore, this addressing scheme facilitates support for more messaging systems in the future. Specifically with regard to social networks, every social network user is provided with a unique ID on the same social network and the same ID is used by other users of the same social network in order to identify the user and communicate with the same user. The present invention combines a unique messaging system ID with the same unique ID used by the same social network to form a unique user ID which is unique across the full range of messaging systems available and ones that will be available in the future.

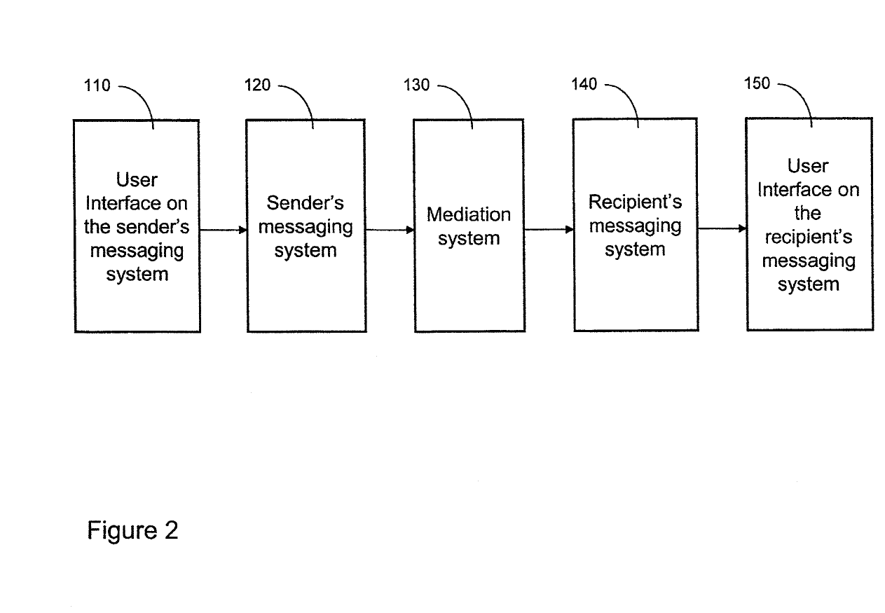

FIG. 2 is a simplified flowchart illustration of a cross-messaging-system messaging system constructed and operative in accordance with an embodiment of the present invention. The sender of a cross-messaging-system message will use the user interface on the messaging system used by that user (box #110) to compose the message and specify the recipient(s) of the message. Once the message is composed and ready to be sent, the user interface will transfer the sending transaction to the messaging system it belongs to (box #120) along with all the message information including message content and recipient(s). the messaging system will identify by the recipient's address that the message is intended for a user of another messaging system and will consequently transfer the message to a mediation system (box #130). The mediation system will transfer the message to its target messaging system (box #140) which upon receipt of the message will send it to its intended recipient to whime the message will be displayed through the user interface of the messaging system in use by the same recipient (box #150).

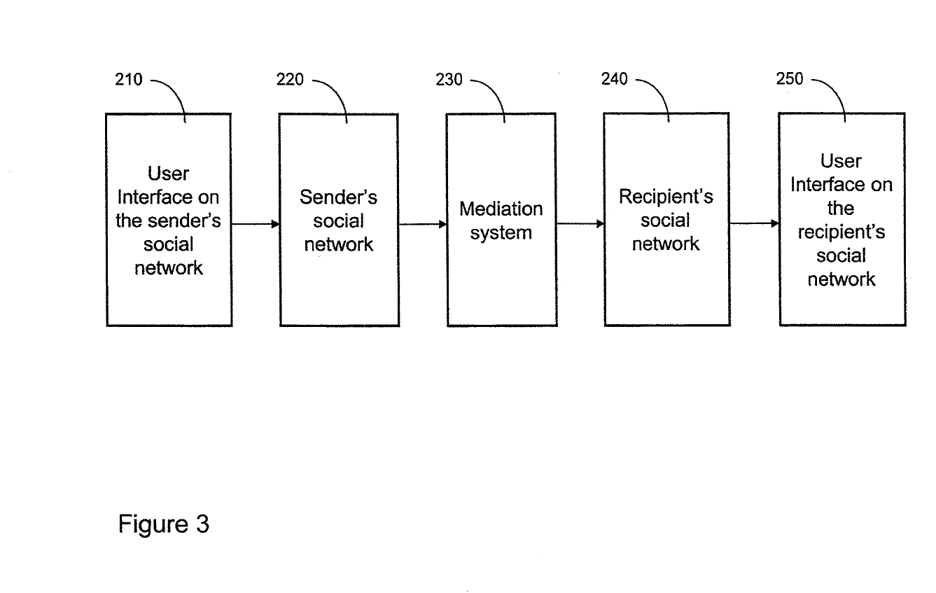

FIG. 3 is a simplified flowchart illustration of a cross-messaging-system system constructed and operative in accordance with an embodiment of the present invention in which each of the messaging systems is a different social network. The sender of a cross-messaging-system message (which is in this case a cross-social-network message) will use the user interface on a social network the same user is registered to (box #210). This user interface might be provided b the social network or alternatively by a 3rd party through a mechanism provided by the social network to such 3rd parties (a popular such mechanism provided by many social networks is the option for 3rd parties to develop their own applications which can be installed and used by users of the same social network). Once the message is composed and is ready to be sent, the user interface transfers the sending transaction to the underlying messaging system which might be an integral part of the social network or a 3rd party server which is used as the back end component of the 3rd party social network application. The underlying messaging system analyzes the recipient ID and in case it identifies the recipient as a user of another social network, it transfers the message to the social network to which the recipient user belongs (box #240) either directly or though a mediation system (box #230). The received messages might be handled by the social network itself or alternatively by a 3rd party application running on the same social network. This social network delivers the received message to its intended recipient user through the user interface used by the same user (box #250) which might be either the native user interface of the social network or the user interface of a 3rd party application running on the same social network. The delivery to the recipient user might involve one or more of the following: sending a notification via SMS, sending a notification via e-mail, displaying a pop-up notification, displaying an indication on the user's regular display and/or any other audio and/or visual mean of notification.

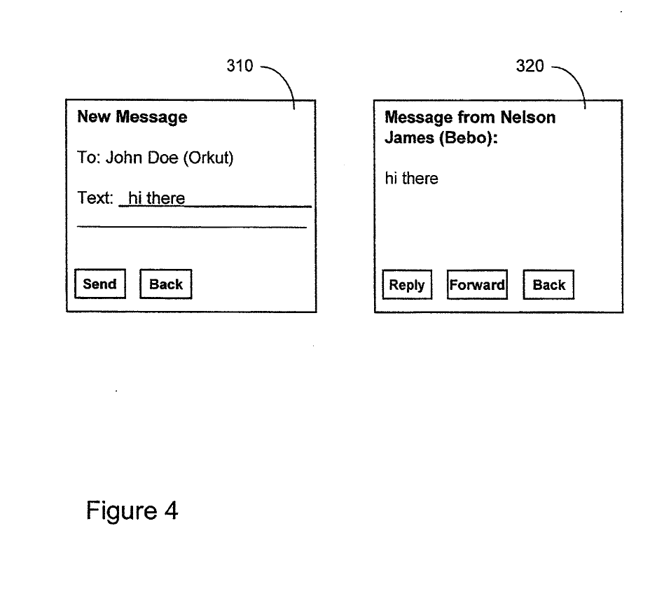

FIG. 4 s a simplified pictorial illustration of a sequence of preferred screen shots for the sending and receiving of a cross-messaging-system message. The sending user is using an interface similar to the one depicted in box #310 to enter the message text and to select the message recipient who in this case is a user of a different messaging system which might be a different social network. Once the message is sent it is received by the recipient using an interface similar to the one depicted in box #320 to read the message, see the sender of this message, who is a user of a different messaging system which might be a different social network and be able to reply to the sender or to the sender and to other message recipients in a case of a group message which contains the list of the other recipients.

It will also be understood that the system and method according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While various embodiments have been shown and described, it will be understood that there is no intent to limit the invention by such disclosure, but rather, it is intended to cover all modifications and alternate constructions falling within the scope of the invention, as defined in the appended claims.

1. A method to enable messaging between users of different social networks.

2. A method to enable messaging between users of social networks and users of other communication systems which are not social networks.

3. The method according to claim 2, wherein the communication system is a cellular network and the users of the communication system are mobile users.

4. The method according to claim 2, wherein the communication system is e-mail and the users of the communication system are identified by their e-mail addresses.

5. The method according to claim 2, wherein the communication system is an instant messaging system and the users of the communication system are identified by their instant messaging ID.
